(19) United States
(12) Patent Application Publication
(10) Pub. No.: US 2024/0244993 A1
(43) Pub. Date: Jul. 25, 2024

(54) BOUNDARY POSITIONING DEVICE

(71) Applicant: URSrobot AI Inc., Taipei City (TW)

(72) Inventors: Chin-Cheng HUANG, Taipei City (TW); Po-Ting LI, Taipei City (TW); Chung-Hou WU, Taipei City (TW); Chao-Cheng CHEN, Taipei City (TW)

(21) Appl. No.: 18/503,660

(22) Filed: Nov. 7, 2023

(30) Foreign Application Priority Data
Jan. 19, 2023 (TW) 112102599

(51) Int. Cl. A01D 34/00; G05D 1/02

(52) U.S. Cl. CPC A01D 34/008; G05D 1/0212; A01D 2101/00

(57) ABSTRACT

A boundary positioning device is adapted to pre-record a boundary of a to-be-worked area where an automatic mechanical equipment will be working. The boundary positioning device includes a machine frame, two wheels, a push rod, and a positioning module.

When the boundary positioning device moves along the boundary, one of the wheels is located inside the to-be-worked area as an inner wheel, and the other one of the wheels is located outside the to-be-worked area as an outer wheel. The push rod extends rearwardly and upwardly from a rear side of the machine frame. The positioning module is disposed on the machine frame, and is spaced apart from the outer wheel by a distance same as a distance between a positioning unit and an outside-located wheel, which is located outside the to-be-worked area when the automatic mechanical equipment moves along the boundary of the automatic mechanical equipment.

### CROSS-REFERENCE TO RELATED APPLICATION

This application claims priority to Taiwanese Invention Patent Application No. 11/210,2599, filed on Jan. 19, 2023.

### FIELD

The disclosure relates to a boundary positioning device, and more particularly to a boundary positioning device adapted to pre-record a boundary of a to-be-worked area where an automatic mechanical equipment will be working.

### BACKGROUND

Generally, a lawn requires regular mowing to maintain its beauty. An automated lawn mower, i.e., a mowing robot, which is developed to save manpower, can automatically mow grasses in a predetermined region of the lawn.

Conventionally, the mowing robot recognizes the predetermined region by a metal wire that is disposed on a boundary of the predetermined region. However, when the predetermined region is relatively large, not only a large amount of the metal wire is required, but disposition of the metal wire is also not easy.

### SUMMARY

Therefore, an object of the disclosure is to provide a boundary positioning device that can alleviate at least one of the drawbacks of the prior art.

According to the disclosure, an aspect of the boundary positioning device is adapted to pre-record a boundary of a to-be-worked area where an automatic mechanical equipment will be working. The automatic mechanical equipment includes a positioning unit and an outside-located wheel that is located outside the to-be-worked area when the automatic mechanical equipment moves along the boundary. The boundary positioning device includes a machine frame, two wheels, a push rod, a positioning module, and a circuit module.

The two wheels are respectively connected to a left side and a right side of the machine frame. One of the wheels is an inner wheel that is located inside the to-be-worked area when the boundary positioning device moves along the boundary, and the other one of the wheels is an outer wheel that is located outside the to-be-worked area when the boundary positioning device moves along the boundary.

The push rod is connected to a rear side of the machine frame and extends rearwardly and upwardly from the machine frame along a central axis.

The positioning module is disposed on the machine frame, and is spaced apart from the outer wheel of the wheels in a left-right direction by a distance same as a distance between the positioning unit and the outside-located wheel of the automatic mechanical equipment.

The circuit module is disposed on the machine frame and is electrically coupled to the positioning module.

Another aspect of the boundary positioning device includes a machine frame, two wheels, a push rod, a positioning module, and a circuit module.

The two wheels are respectively connected to a left side and a right side of the machine frame.

The push rod is connected to a rear side of the machine frame, and extends rearwardly and upwardly from the machine frame along a central axis.

The positioning module is disposed on the machine frame.

The circuit module is disposed on the machine frame, and includes a control unit that is electrically coupled to the positioning module, a dynamic sensing unit that is electrically coupled to the control unit and that is adapted for sensing a tilt angle of the positioning module, and an output unit that is electrically coupled to the control unit.

The control unit controls the output unit to indicate whether the tilt angle of the positioning module falls within a predetermined tilt angle range according to the tilt angle sensed by the dynamic sensing unit. The positioning module substantially faces upward when the tilt angle thereof is within the predetermined tilt angle range.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view of a boundary positioning device according to an embodiment of the disclosure.

FIG. 2 is another perspective view of the embodiment taken from another angle, illustrating a foot of the embodiment in a folded position.

FIG. 3 is a perspective view similar to FIG. 2, illustrating the foot in a support position.

FIG. 4 is a partial exploded view of the embodiment.

FIG. 5 is a partial exploded view of the embodiment.

FIG. 6 is a rear view of the embodiment.

FIG. 7 is a side view of the embodiment.

FIG. 8 is a view similar to FIG. 3, illustrating a movable rod body of a push rod of the embodiment in a folded position.

FIG. 9 is a block diagram illustrating a circuit module of the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

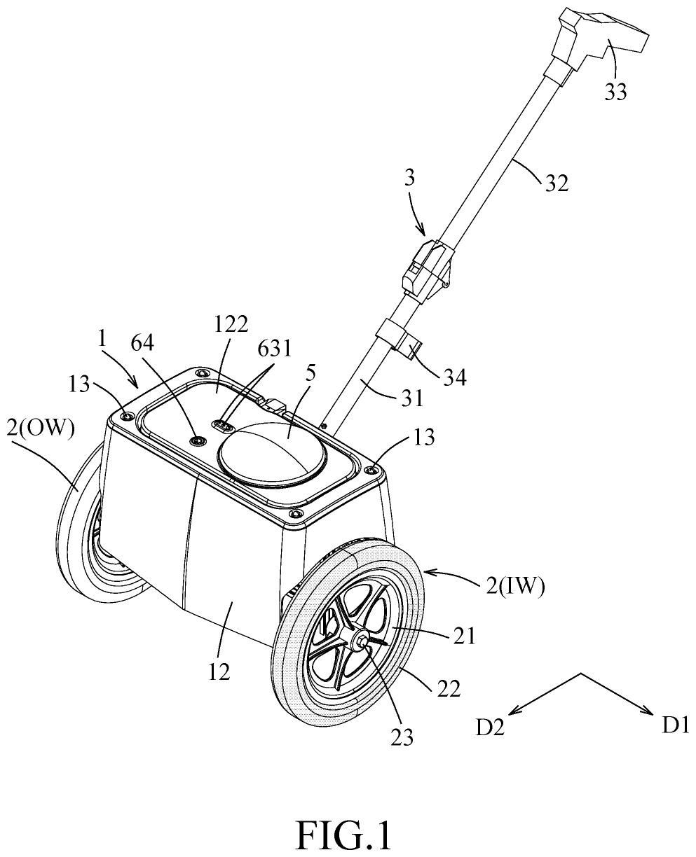

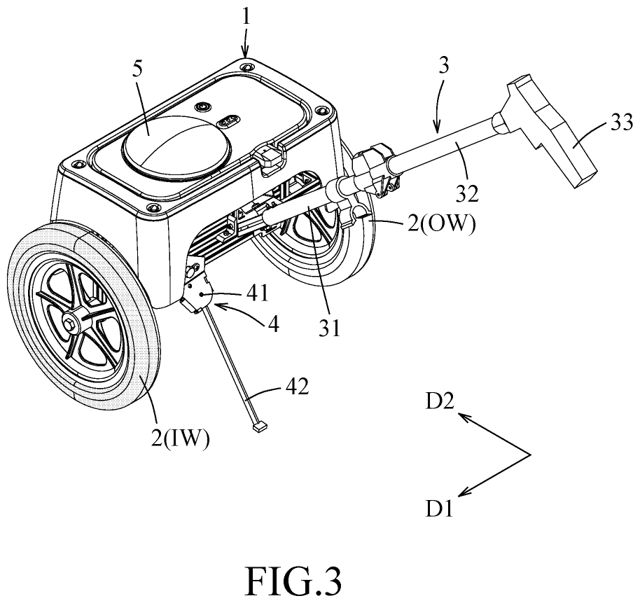

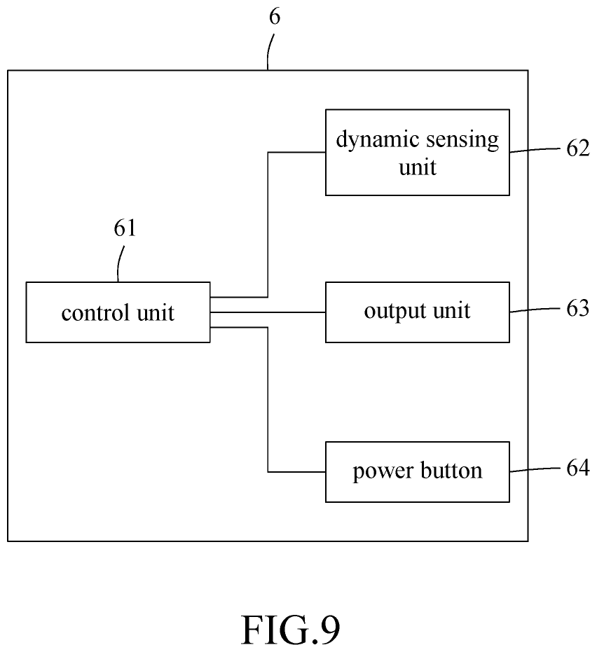

Referring to FIGS. 1 to 3, an embodiment of a boundary positioning device of the disclosure is adapted to pre-record a boundary of a to-be-worked area where an automatic mechanical equipment (not shown) will be working. The automatic mechanical equipment includes a positioning unit, and an outside-located wheel that is located outside the to-be-worked area when the automatic mechanical equipment moves along the boundary. In the following, the boundary positioning device is described along with the automatic mechanical equipment which is exemplified as a mowing robot, but the automatic mechanical equipment may be an automatic cultivator, an automatic seeder, etc. In this embodiment, the boundary positioning device includes a machine frame 1, two wheels 2, a push rod 3, a support module 4, a positioning module 5, and a circuit module 6 (see FIG. 9).

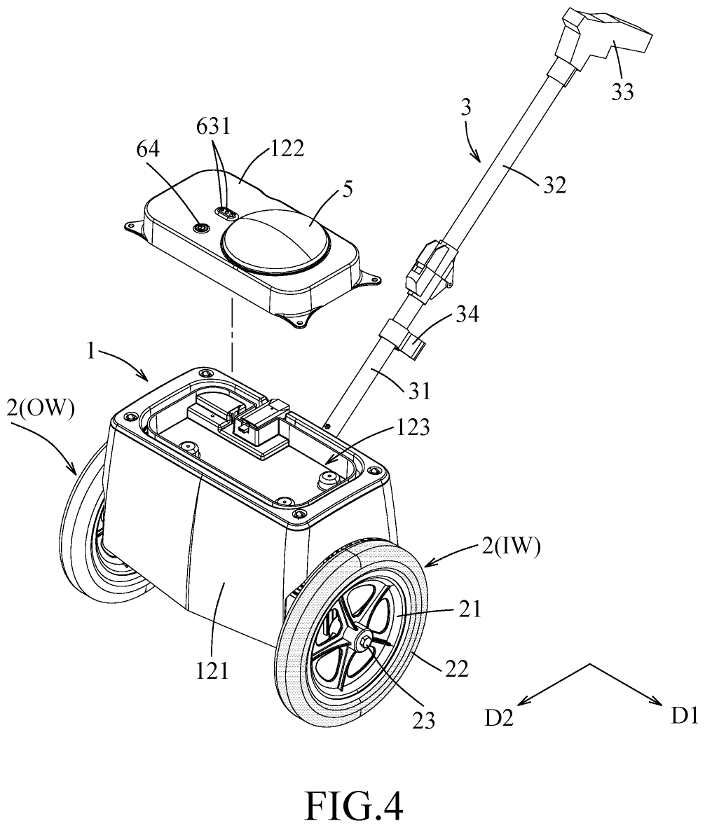

Referring to FIGS. 4 to 6, the machine frame 1 includes a frame body 11, a casing 12 that is disposed on the frame body 11, and four fixed threaded rods 13 that are disposed on the frame body 11. In this embodiment, the frame body 11 includes a top frame 111, two side upright rods 112, a bottom cross rod 113, a semi-frame 114, and a rear upright rod 115. The top frame 111 includes a front rod portion 111a that extends in a left-right direction (D1), an upper rear rod portion 111b that is spaced apart from the front rod portion 111a in a front-rear direction (D2), and two upper side rod portions 111c that are respectively connected to left ends and right ends of the front rod portion 111a and the upper rear rod portion 111b. The side upright rods 112 are respectively connected to bottom sides of the upper side rod portions 111c and are close to the front rod portion 111a. The bottom cross rod 113 is connected to the side upright rods 112 and is close to bottom ends of the side upright rods 112. The semi-frame 114 is disposed between the top frame 111 and the bottom cross rod 113, and includes a lower rear rod portion 114a that is disposed below the upper rear rod portion 111b, and two lower side rod portions 114b that are respectively connected to two ends of the lower rear rod portion 114a and that are respectively connected to rear sides of the side upright rods 112. The rear upright rod 115 connects a middle of the upper rear rod portion 111b and a middle of the lower rear rod portion 114a together. The casing 12 includes a base 121 and a top cover 122; the base 121 and the top cover 122 cooperatively define an accommodating space 123. The fixed threaded rods 13 extend respectively through four corners of the casing 12 and are respectively fixed to four corners of the top frame 111 so as to fix the casing 12 to the frame body 11.

The wheels 2 are respectively connected to a left side and a right side of the frame body 11. One of the wheels 2 is an inner wheel (IW) that is located inside the to-be-worked area when the boundary positioning device moves along the boundary, and the other one of the wheels 2 is an outer wheel (OW) that is located outside the to-be-worked area when the boundary positioning device moves along the boundary. Specifically, when the boundary positioning device and the automatic mechanical equipment respectively move along the boundary, a traveling path of the inner wheel (IW) is substantially the same as a traveling path of a working tool of the automatic mechanical equipment (e.g., blades of the mowing robot), and a traveling path of the outer wheel (OW) is substantially the same as a traveling path of the outside-located wheel of the automatic mechanical equipment. Each of the wheels 2 includes a wheel frame 21, a tire 22, and an axle 23. In this embodiment, the axles 23 of the wheels 2 are respectively connected to the side upright rods 112 and are located below the bottom cross rod 113. In order for a user to easily remember which one of the wheels 2 is the inner wheel (IW), the inner wheel (IW) has a marking feature for recognition by the user. In this embodiment, a color of the tire 22 of the inner wheel (IW) is different from a color of the tire 22 of the outer wheel (OW), the marking feature of the inner wheel (IW) is the color of the tire 22 of the inner wheel (IW). For example, the left one of the wheels 2 is the inner wheel (IW) and the color of the tire 22 of the inner wheel (IW) is green, and the right one of the wheels 2 is the outer wheel (OW) and the color of the tire 22 of the outer wheel (OW) is black, which is a common tire color. Therefore, the user may intuitively understand the traveling path of the left one of the wheels 2 (which is the inner wheel (IW) corresponding to the working tool of the automatic mechanical equipment) that defines a region where the automatic mechanical equipment actually works.

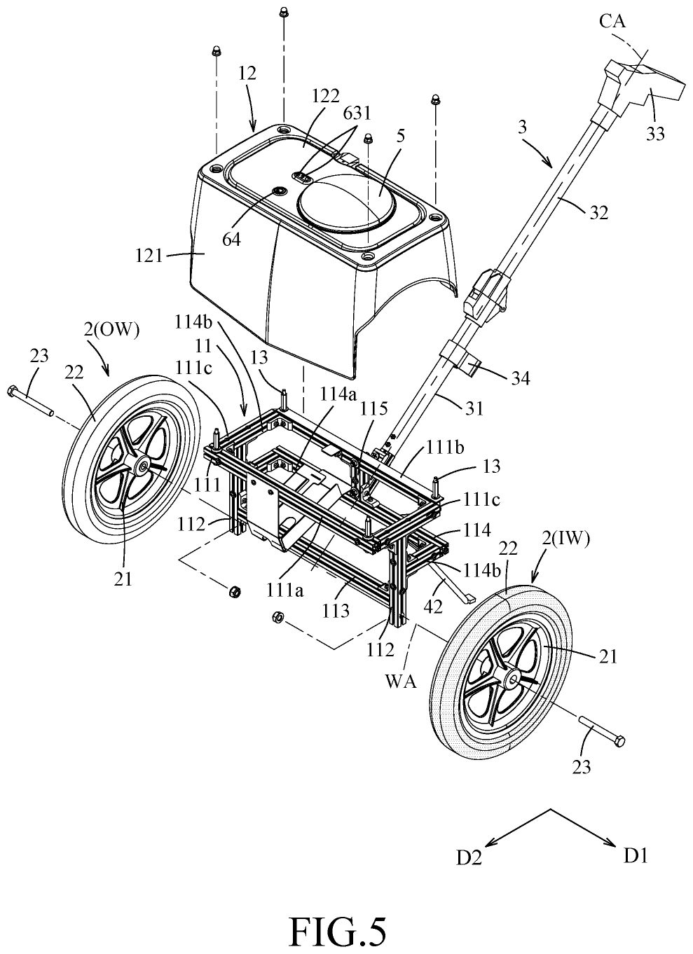

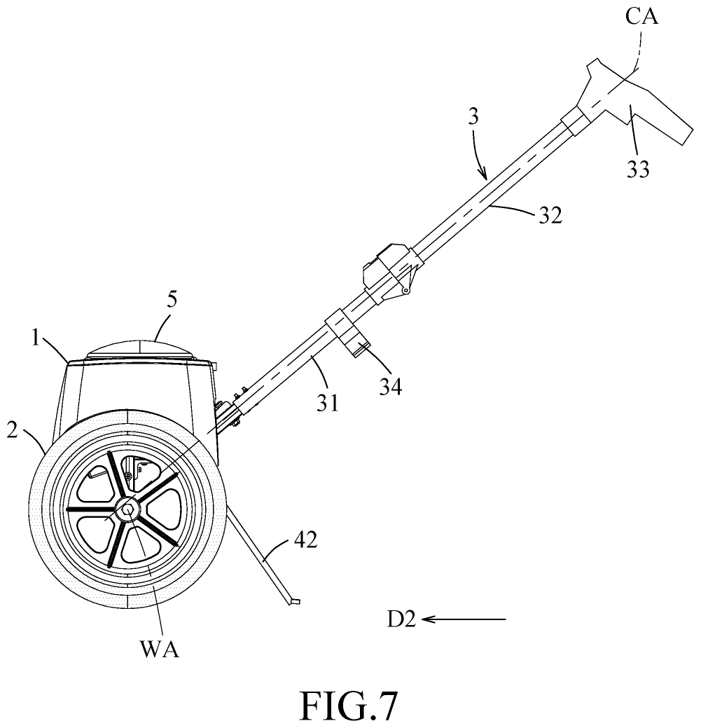

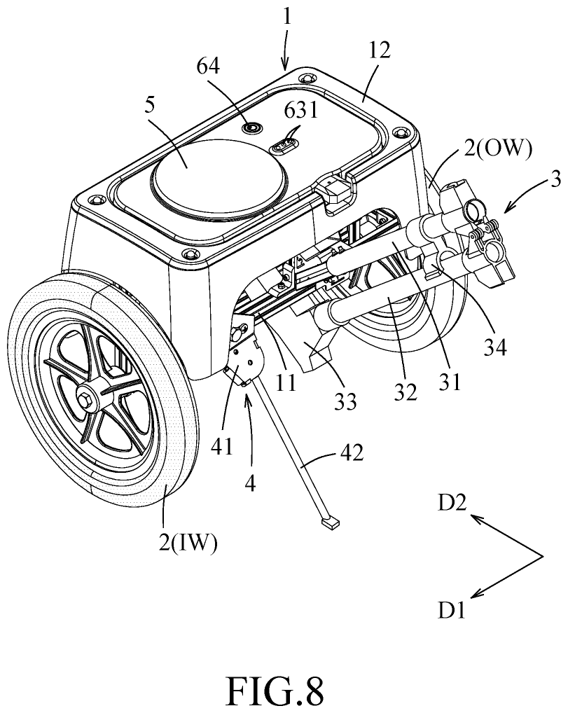

Referring to FIGS. 5 to 8, the push rod 3 is connected to a rear side of the frame body 11 of the machine frame 1, and extends rearwardly and upwardly from the frame body 11 along a central axis (CA). In this embodiment, the push rod 3 resides in a imaginary plane, the imaginary plane is perpendicular to a wheel axis (WA) that the wheels 2 rotate around and passes through a midpoint of an imaginary line that interconnects centers of the wheels 2. The central axis (CA) passes above the wheel axis (WA) such that the user may use the push rod 3 to easily push the machine frame 1 and to easily control directions of the wheels 2. Furthermore, in this embodiment, the push rod 3 includes a fixed rod body 31 that is connected to the frame body 11, a movable rod body 32 that is pivotally connected to the fixed rod body 31 so that the push rod 3 is foldable, and a handgrip 33 that is connected to an end of the movable rod body 32 distal from the fixed rod body 31 for the user to grip. The movable rod body 32 changes between a use position (shown in FIG. 7), where the movable rod body 32 extends along the central axis (CA), and a folded position (shown in FIG. 8), where the movable rod body 32 overlaps the fixed rod body 31. The push rod 3 may further include a holding member 34 that is disposed on the fixed rod body 31 and that is used to fix the movable rod body 32 in the folded position. When the movable rod body 32 is in the folded position, the movable rod body 32 is located below the fixed rod body 31 and the handgrip 33 is located below the frame body 11, thereby reducing the overall size of the boundary positioning device for carriage and storage. In this embodiment, the handgrip 33 has a stepped structure which is similar to the shape of a grip and a trigger guard of a pistol, and which is easy to hold, thereby increasing the comfort of use.

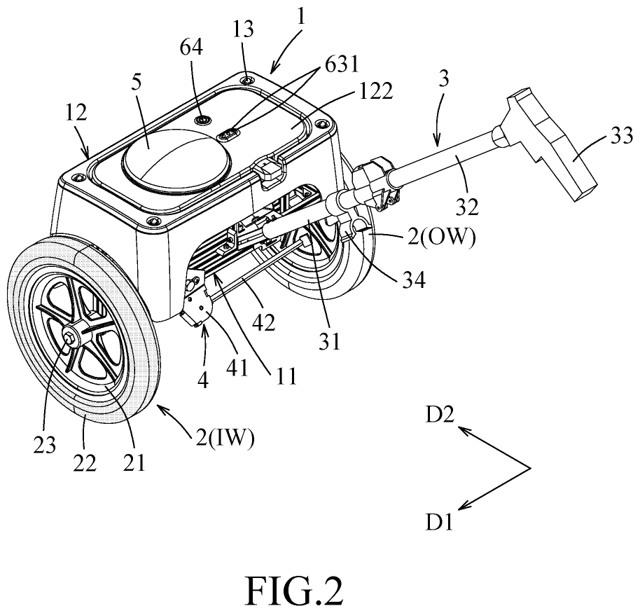

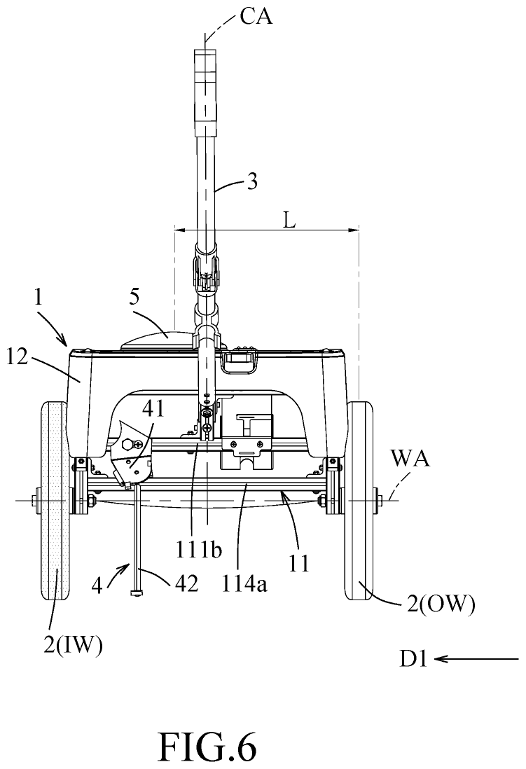

Referring to FIGS. 2, 6 and 7, the support module 4 includes a fixed seat 41 that is connected to the frame body 11, and a foot 42 that is pivotally connected to the fixed seat 41. The fixed seat 41 is connected to a rear side of the lower rear rod portion 114a of the frame body 11 and is close to the left one of the wheels 2 so as not to align with the push rod 3. The foot 42 changes between a support position (shown in FIGS. 6, 7), where the foot 42 stands on the ground to support the machine frame 1, and a folded position (shown in FIG. 2), where the foot 42 is close to the machine frame 1 and away from the ground. Specifically, one end of the foot 42 is pivotally connected to the fixed seat 41 and is close to the left one of the wheels 2, and the other end of the foot 42 is close to the right one of the wheels 2 when the foot 42 is in the folded position, so that the foot 42 may be stored below the frame body 11 and extends between the wheels 2. It can be understood that the same function can be achieved in some embodiments where the fixed seat 41 is close to the right one of the wheels 2, and the one end of the foot 42 that is pivotally connected to the fixed seat 41 is close to the right one of the wheels 2, and the other end of the foot 42 is close to the left one of the wheels 2 when the foot 42 is in the folded position. When the boundary positioning device stops moving, the foot 42 may be positioned in the support position to keep the machine frame 1 upright, such that a satellite receiving antenna of the positioning module 5, which is described below, may be parallel with the ground to achieve optimal signal reception. When the boundary positioning device moves, the foot 42 may be positioned in the folded position to not to affect movement of the boundary positioning device.

Referring to FIGS. 2 and 6, the positioning module 5 is used to record a travelling path of the boundary positioning device that is to be provided to the automatic mechanical equipment as the boundary of the to-be-worked area. In this embodiment, the positioning module 5 is a GPS module, but is not limited to this embodiment, the positioning module 5 may be a positioning module using GPS in combination with other positioning system technologies. The positioning module 5 is disposed on the top cover 122 of the casing 12 of the machine frame 1, and is spaced apart from the outer wheel (OW) of the wheels 2 in the left-right direction (D1) by a distance (L) the same as a distance between the positioning unit and the outside-located wheel of the automatic mechanical equipment, so as to ensure that, when the automatic mechanical equipment moves along the boundary, the traveling path of the outside-located wheel of the automatic mechanical equipment is the same with the traveling path of the outer wheel (OW) of the wheels 2 of the boundary positioning device, such that the outside-located wheel of the automatic mechanical equipment may be prevented from encountering an obstacle or coming off the ground.

Referring to FIGS. 4 and 9, the circuit module 6 is disposed on the casing 12 of the machine frame 1 and is electrically coupled to the positioning module 5. In this embodiment, the circuit module 6 is disposed mainly in the accommodating space 123, and includes a control unit 61 that is electrically coupled to the positioning module 5, a dynamic sensing unit 62 that is electrically coupled to the control unit 61 and that is adapted for sensing a tilt angle of the positioning module 5, an output unit 63 that is electrically coupled to the control unit 61, and a power button 64 that is electrically coupled to the control unit 61. The control unit 61 controls the output unit 63 to indicate whether the tilt angle of the positioning module 5 falls within a predetermined tilt angle range according to the tilt angle sensed by the dynamic sensing unit 62. The positioning module 5 faces substantially upward when the tilt angle thereof is within the predetermined tilt angle range. Furthermore, the control unit 61 controls the output unit 63 to indicate the reception status of the positioning module 5. In this embodiment, the dynamic sensing unit 62 includes a gyroscope (not shown), and the output unit 63 includes a plurality of indicator lights 631. The indicator lights 631 and the power button 64 are disposed on the top cover 122 of the casing 12 to facilitate users to view the indicator lights 631 and to operate the power button 64. The indicator lights 631 may display different colors in different lighting modes (e.g., always-on mode and blinking mode) to indicate whether the tilt angle of the positioning module 5 falls within the predetermined tilt angle range, and to indicate the reception status of the positioning module 5, which may be good, average, or poor. Thus, the user may according to the indications of the indicator lights 631, decide whether to adjust angle of the push rod 3 so as to ensure that the reception status of the positioning module 5 is stable and to obtain accurate positioning data. In some embodiments, the indications of whether the tilt angle falls within the predetermined tilt angle range and the reception status of the positioning module 5 may be provided by sounds.

In this embodiment, a center of gravity of an assembly of the machine frame 1, the positioning module 5, and the circuit module 6 is located behind the wheel axis (WA) that the wheels 2 rotate around, such that the user may easily push the boundary positioning device and control the direction of the boundary positioning device with the push rod 3. Since the inner wheel (IW) is located on the left side of the boundary positioning device in this embodiment, the boundary positioning device pushed by the user needs to move in the counterclockwise direction along the boundary so that the inner wheel (IW) is located inside the to-be-worked area and the outer wheel (OW) is located outside the to-be-worked area. On the other hand, when the inner wheel (IW) is on the right side of the boundary positioning device, the boundary positioning device need to move in the clockwise direction along the boundary.

In summary, the boundary positioning device of the disclosure is easy to operate by the user for recording the boundary of the to-be-worked area to be provided to the automatic mechanical equipment such that the metal wire may be saved and the automatic mechanical equipment is easier to operate.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A boundary positioning device adapted to pre-record a boundary of a to-be-worked area where an automatic mechanical equipment will be working, the automatic mechanical equipment including a positioning unit, and an outside-located wheel that is located outside the to-be-worked area when the automatic mechanical equipment moves along the boundary, said boundary positioning device comprising:
a machine frame;
two wheels respectively connected to a left side and a right side of said machine frame, one of said wheels being an inner wheel that is located inside the to-be-worked area when said boundary positioning device moves along the boundary, and the other one of said wheels being an outer wheel that is located outside the to-be-worked area when said boundary positioning device moves along the boundary;
a push rod connected to a rear side of said machine frame and extending rearwardly and upwardly from said machine frame along a central axis;
a positioning module disposed on said machine frame and spaced apart from said outer wheel of said wheels in a left-right direction by a distance same as a distance between the positioning unit and the outside-located wheel of the automatic mechanical equipment; and
a circuit module disposed on said machine frame and electrically coupled to said positioning module.

2. The boundary positioning device as claimed in claim 1, wherein the central axis passes above a wheel axis that said wheels rotate around, said push rod residing in an imaginary plane, the imaginary plane being perpendicular to the wheel axis and passing through a midpoint of an imaginary line that interconnects centers of said wheels, said inner wheel of said wheels having a marking feature for recognition by a user.

3. The boundary positioning device as claimed in claim 2, wherein each of said wheels includes a wheel frame and a tire, a color of said tire of said inner wheel of said wheels being different from a color of said tire of said outer wheel of said wheels, the marking feature being the color of said tire of said inner wheel.

4. The boundary positioning device as claimed in claim 1, further comprising a support module, said support module including a fixed seat that is connected to said machine frame, and a foot that is pivotally connected to said fixed seat, said foot changing between a support position where said foot stands on a ground to support said machine frame, and a folded position where said foot is close to said machine frame and away from the ground.

5. The boundary positioning device as claimed in claim 4, wherein said fixed seat is connected to the rear side of said machine frame and is close to one of said wheels, one end of said foot being pivotally connected to said fixed seat so that the one end of said foot is close to the one of said wheels, the other end of said foot being close to the other one of said wheels when said foot is in the folded position.

6. The boundary positioning device as claimed in claim 1, wherein said push rod includes a fixed rod body connected to said machine frame, a movable rod body pivotally connected to said fixed rod body so that said push rod is foldable, and a handgrip connected to an end of said movable rod body that is distal from said fixed rod body for a user to grip, said movable rod body changing between a use position where said movable rod body extends along the central axis, and a folded position where said movable rod body overlaps said fixed rod body, said handgrip having a stepped structure which is easy to hold.

7. The boundary positioning device as claimed in claim 1, wherein a center of gravity of an assembly of said machine frame, said positioning module, and said circuit module is located behind a wheel axis that said wheels rotate around.

8. The boundary positioning device as claimed in claim 1, wherein said circuit module includes a control unit electrically coupled to said positioning module, and an output unit electrically coupled to said control unit, said control unit controlling said output unit to indicate a reception status of said positioning module.

9. The boundary positioning device as claimed in claim 1, wherein said circuit module includes a control unit electrically coupled to said positioning module, a dynamic sensing unit electrically coupled to said control unit and adapted for sensing a tilt angle of said positioning module, and an output unit electrically coupled to said control unit, said control unit controlling said output unit to indicate whether the tilt angle of said positioning module falls within a predetermined tilt angle range according to the tilt angle sensed by said dynamic sensing unit, said positioning module substantially facing upward when the tilt angle thereof is within the predetermined tilt angle range.

10. A boundary positioning device comprising:
a machine frame;
two wheels respectively connected to a left side and a right side of said machine frame;
a push rod connected to a rear side of said machine frame, and extending rearwardly and upwardly from said machine frame along a central axis;
a positioning module disposed on said machine frame; and
a circuit module disposed on said machine frame and including a control unit electrically coupled to said positioning module, a dynamic sensing unit electrically coupled to said control unit and adapted for sensing a tilt angle of said positioning module, and an output unit electrically coupled to said control unit,
said control unit controlling said output unit to indicate whether the tilt angle of said positioning module falls within a predetermined tilt angle range according to the tilt angle sensed by said dynamic sensing unit, said positioning module substantially facing upward when the tilt angle thereof is within the predetermined tilt angle range.
